(19) United States
(12) Patent Application Publication
(10) Pub. No.: US 2026/0357559 A1
(43) Pub. Date: Nov. 12, 2026

(54) MODULAR HOUSING CONSTRUCTION

(71) Applicant: John G. ROOK, San Bruno, CA (US)

(72) Inventor: John G. ROOK, San Bruno, CA (US)

(21) Appl. No.: 19/125,721

(22) PCT Filed: Oct. 31, 2023
(86) PCT No.: PCT/US2023/078288

§ 371 Date: Apr. 29, 2025

Related U.S. Application Data
(60) Provisional application No. 63/475,343, filed on Oct. 31, 2022.
(60) Provisional application No. 63/495,925, filed on Apr. 13, 2023.

(51) Int. Cl. E04B 1/344; E04B 1/348; E04B 1/35

(52) U.S. Cl. CPC E04B 1/3442; E04B 1/3511; E04B 2001/34876

(57) ABSTRACT

A modular home construction system that can be towed to the building site by conventional pick up, or SUV type vehicles. A floor panel, first wall panel, a second wall panel, and a roof panel are hinged together to form a single module. The module is either left on its transport vehicle, or installed on a foundation. Modules can be connected side by side to form as large a structure as needed. A left and right wall or wall sections are installed to complete the housing envelope.

### CROSS REFERENCE TO RELATED APPLICATIONS

This application claims priority to U.S. Provisional Patent Application Ser. No. 63/475,343 entitled “Modular Housing Construction” filed on Oct. 31, 2022, and to U.S. Provisional Patent Application Ser. No. 63/495,925 filed on Apr. 13, 2023, entitled “Modular Housing Construction,” each of which are incorporated by reference in its entirety for all purposes.

### FIELD OF THE INVENTION

Some applications of the present invention generally relate to the field of housing construction techniques and more specifically to a modular pre-fabricated housing system.

### BACKGROUND OF THE INVENTION

Current housing construction techniques usually involve on site frame and roof construction that takes considerable time and results in unwanted waste material. Another form of pre-fabricated construction includes designing with structural insulated panels or SIP panels. The use of SIP panels may save the assembly time of nailing individual studs and rafters, but still require significant time to cut panels to size and fasten one panel assembly to the next and install windows. Other pre-fabricated home construction techniques have been developed, but none of them provide the ease or advantages of the transportation, assembly and modularity of the inventive modular system described herein.

### SUMMARY OF THE INVENTION

In one aspect, there is provided a modular housing construction system having a floor panel having a front end and a rear end, a roof panel having a front end and a rear end, a front wall panel having a top end and a bottom end and a rear wall panel having a top end and a bottom end. Additionally, the roof panel rear end is fixedly connected to the top end of the rear wall panel, a top hinge connecting the front wall panel top end to the roof panel front end, a rear hinge connecting the floor panel rear end to the rear wall panel bottom end, and the front panel bottom end is in a sliding arrangement with the floor panel. In still other aspects, sliding the front panel bottom end along the floor panel towards the floor panel front end elevates the roof panel relative to the floor panel. In an additional aspect, sliding the front panel bottom end along the floor panel towards the floor panel front moves the top hinge connection between the front end of the roof panel and the front panel top end. Still other aspects, sliding the front panel bottom end along the floor panel towards the floor panel front end moves the rear wall panel top end towards a vertical orientation relative to the floor panel and/or sliding the front panel bottom end along the floor panel towards the floor panel front end moves the rear hinge connection to change the rear wall panel top end relative to the floor panel. In still another aspect, there is an embodiment where the top hinge is positioned 8 feet from the roof panel front end or at a distance to provide an overhang of a portion of the roof panel front end over the floor panel front end. In yet another variation, the rear hinge is positioned from floor panel rear end so as to align the rear panel bottom with the floor panel rear end, to form a ledge between the rear wall and the floor panel or to form an overhang of a portion of the rear wall over the floor panel rear end.

In another embodiment, the roof panel includes a left side and a right side extending from the front end to the rear end, the left side or the right side having an upper protrusion or a lower protrusion for joining to an adjacent roof panel. Additionally, when the roof panel is joined to an adjacent roof panel there is a hollow channel between the roof panels. In still another aspect, joining together a plurality of single module assemblies in side-by-side arrangement to form a housing structure of a desired width. In still other alternatives, the modular housing system is adapted and configured for transportation on a trailer hauled by a conventional pick-up truck or SUV type vehicle. In additional alternatives, the modular housing system is in a transportation configuration on a trailer the highest point is the roof panel above the rear wall panel and that highest point is less than 13 feet above a roadway and the longest portion of the modular housing system is the front end of the roof panel and that longest portion is less than 32 feet from a front end of the trailer holding the modular housing system.

In yet another embodiment, the modular system includes a plurality of a left and right-side wall panels sized to enclose the space created by the roof panel, the rear wall panel, the floor panel, and the front wall panel. Additionally or optionally, in some embodiments, each side panel of the plurality of left and right side panels is one of a front portion panel, a mid-portion panel or a rear portion panel wherein a front portion panel has a bottom surface adapted and configured for attachment to the floor panel and an upper surface adapted and configured for conforming along and attaching to a portion of the roof panel, wherein a rear portion panel has a bottom surface adapted and configured for attachment to the floor panel, an upper surface adapted and configured for conforming to a portion of the roof panel and an edge portion adapted and configured for attachment to the rear wall panel, wherein a mid-portion panel has a bottom surface adapted and configured for attachment to the floor panel and an upper surface adapted and configured for conforming to a portion of the roof panel between the front panel portion and the rear panel portion.

In still other embodiments, any of the above described modular systems the roof member and the rear wall member are molded of fire-retardant class 1 composite monolithic fiberglass and foam insulation.

In yet another aspect, there is a cable coupled to the front wall panel bottom end wherein pulling the cable slides the front wall panel bottom end towards the floor panel front end while also raising the roof panel above the floor panel. Additionally, there may also be a winch adapted and configured for pulling the cable until the roof section is raised into a final position.

In yet another variation, there is provided a method of forming a modular housing structure by pulling a cable attached to the front wall panel bottom end of the modular housing construction system of any of the above described embodiments towards the floor panel front end until the front wall panel is in a vertical orientation with the front panel bottom is flat against the flooring panel. Thereafter, after the pulling step is completed the rear wall panel is in a vertical orientation and the rear wall panel bottom end is flat against the floor panel.

### BRIEF DESCRIPTION OF THE DRAWINGS

The drawings constitute a part of this specification and include exemplary embodiments to the various aspects of the invention, which may be embodied in various forms. It is to be understood that in some instance various aspects of an inventive embodiment may be shown exaggerated or enlarged to facilitate an understanding of that aspect or the embodiment as a whole.

The patentable features of the various aspects of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a perspective view of the invention being towed using a transport trailer and a conventional SUV.

FIG. 2 is a perspective view of a module starting to be erected.

FIG. 3 is a side view of a module being erected.

FIG. 4 is a side view of a module fully erected.

FIG. 5 is a perspective view of a plurality of modules connected together.

FIG. 6 is a perspective view of the side walls being installed.

FIG. 7 is a perspective view of a plurality of modules supported by a framework.

FIG. 8 is a perspective view of two roof panels.

FIG. 9 is a perspective view showing two roof panels attached together.

FIG. 10 is a perspective view showing modules oriented to produce a large open work space.

FIG. 11 is a perspective view showing various component of a module stacked for storage.

### DETAILED DESCRIPTION OF THE PREFERRED EMBODIMENTS

In one embodiment, the modular construction system consists of a hinged roof, wall, and floor structure that can be easily transported using common sport utility vehicles (SUVs) or pickup trucks. As a result, the pre-assembled hinged panels can be erected without using heavy equipment while also being delivered using commonly available vehicles, such as pickup trucks and SUVs. Advantageously, due to the inherent modular design, embodiments of the modular construction system can provide major flexibility in the size and orientation of the structure with the same easy set up on site with minimal time and effort. One objective of the design is to provide a very flexible format for ready transportation and building of residential and other structures. The proposed modular format allows for varying the size of the final building by adding additional modules until the square footage of floor space desired is achieved. The height and the length of each section can also be adjusted by putting stops in the mold, allowing for a variety of different size profiles.

The basic module features a three-component assembly. A molded, composite monolithic wall/roof section that is attached to the floor section using hinges. And a front wall section that is hinged to the wall/roof section. The floor section is currently designed using traditional plywood and framing lumber type construction. The front wall section can be a metal frame with windows installed in it. The front wall could also be solid, or have some portion with a window. The monolithic roof/wall section has foam insulation added as part of the composite construction.

Modules would have utilities incorporated into the floor sections, and junction features between the modules. Some could be formatted for kitchen hook ups. Other connections could be used for bathroom, sewage or water hook ups. Still other connections could be provided for open space, with basic electrical installed.

All materials used are construction grade materials. The resin would be Class 1 fire retardant. The foam insulation is also construction grade.

Fire retardant properties can be enhanced by the application of Aircrete Tiles. And by the use of TPR2 type Fire Retardant Intumescent coatings.

The design would be engineered to meet California Building Code Requirements.

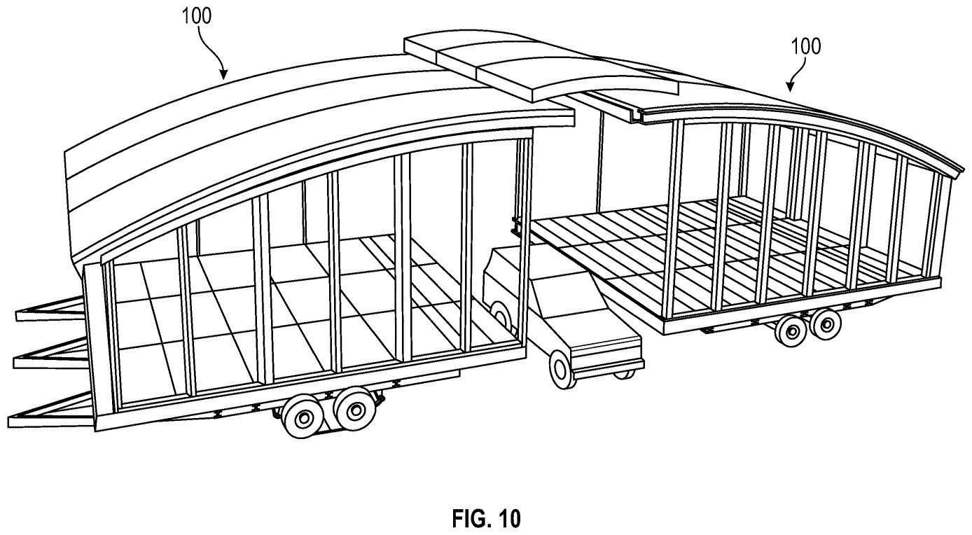

The basic idea is to allow for easy transport to the job site. Easy assembly once the sections are there. Allowing for the structure to be assembled and used while it is still on the transport trailers as is shown in the exemplary embodiment of FIG. 10. Once foundation details, for a more permanent installation, are worked out with the local building department. Then the modules could be moved over onto a final foundation.

The modules are designed to be towed down the road using conventional vehicles. SUVs, or pickup trucks. They do not have “wide load” issues and will fit under all overpasses. Once at the job site, the roof sections are raised using a winch, which uses the front wall as a lever to raise the roof. Once the roof sections are raised, the modules are oriented, side to side, to make up the final length of the building. Details in the roof design shape, allow for a fit that immediately becomes weather tight as soon as the modules are fit together. Once the overall structure is assembled, side wall sections are fitted to the ends to close off the buildings.

Wings made up of additional modules can be added adjacent to the main structure to increase the number of rooms and floor space.

While the original intent of the design was easily assembled and transported housing, the design lends itself to disaster relief. These assemblies stack and can be made up ahead of time and warehoused. Once a need arises the modules can be assembled, roof/wall to floor, at a central location, and moved out into the field without the need for heavy equipment. Assembly is quick and easy. These could be temporary, or permanent housing solutions.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a modular housing construction system; said system compromised of a floor panel, a molded roof/rear wall panel, and a front wall panel, said front wall panel and said roof/wall panel and said floor panel are hingedly connected. Modules are assembled next to each other until desired building size is achieved. Left and right-side wall panels sized to fill the open-end space created by the roof/wall panel, floor panel, and front wall panel are fitted creating a single enclosed modular space.

Single modules are capable of being connected side by side to create a housing structure of any desired width. A module is capable of being transported using common SUVs or pickup trucks towing the modules on transport trailers.

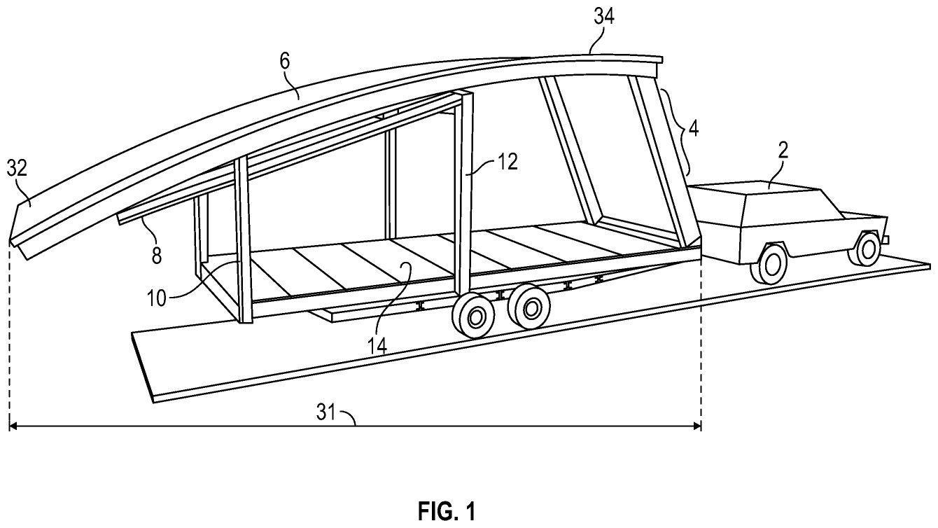

Referring now to FIG. 1, there is a perspective view of a modular housing module 100 in its collapsed state, being transported on a transport trailer, towed by a SUV type vehicle. In one embodiment, the trailer and components of the modular construction system shown in FIG. 1 are within the maximum towing capacity of a standard pickup truck or SUV. In one embodiment, the weight of the components of a modular construction assembly and trailer is less than 16,000 pounds, less than 14,000 pounds, less than 12,000 pounds, less than 10,000 pounds, less than 8,000 pounds, less than 6,000 pounds or between 2500 and 4500 pounds. In one aspect, the total weight of a trailer and the components of an embodiment of a modular construction system is between 4,000 and 5,000 pounds.

In one embodiment, the roof panel 6 is fixedly connected to the rear wall panel 4. Rear panel 4 is hingedly connected to floor panel 14. Front wall panel 8 is hingedly connected to roof panel 6. The overall length of the collapsed module assembly is 32 feet. The overall width is 8 ½ feet. In one aspect, the floor panel is formed from plywood sheets with dimensions of 4 feet by 8 feet along with 2 in×4 in framing. The overall height is approximately 12 foot 9 inches. Two support members 10 and 12 hold the roof member and the front wall 8 up high enough during transport the distal end of the roof panel 6 doesn't touch the ground during transport. This also makes space to haul other items in the open space between front wall panel 8 and floor panel 14. In one aspect, there is a towing envelope within which the components of FIG. 1 will fit and allow that load to be transported using standard towing protocols. In one specific embodiment, an envelope having 8 ½ foot width, 32 foot length, and 12 foot 9 inch overall height means the module can be towed over standard roadway without the need of special wide load permit, and will fit under all standard overpasses. In one aspect, the highest point is the upper portion of the rear wall where it meets the roof panel, the maximum length is from the end of the trailer nearest the vehicle to the front end of the foot module and the maximum width is based on the size of trailer and wheels used for supporting a specific configuration of the modular construction.

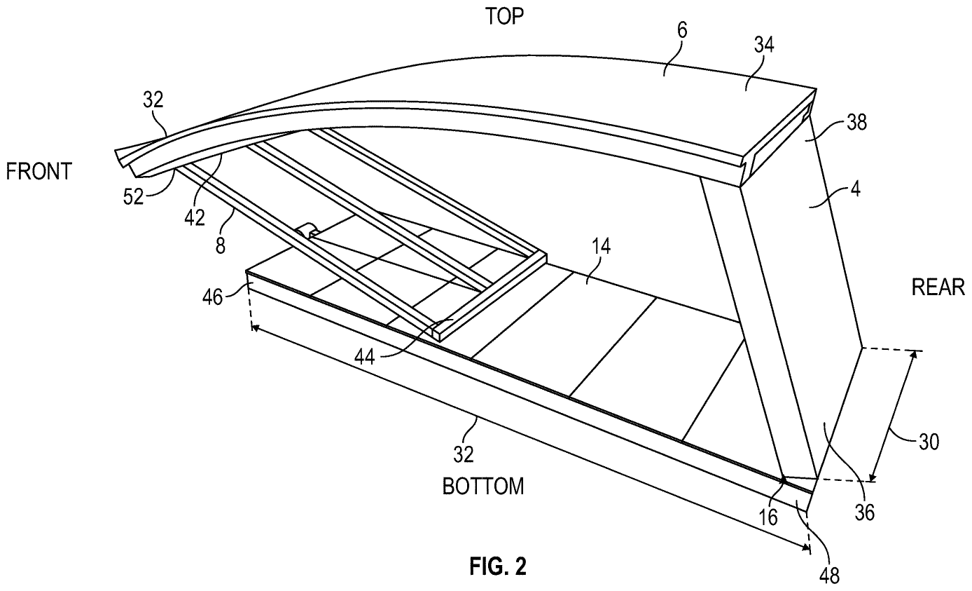

FIG. 2 is a perspective view of the modular housing system 100 partially erected. Roof panel 14 and rear panel 4 are molded from class 1 fire retardant resin to form a composite monolithic wall and roof section. The floor panel 14 is currently envisioned as being constructed using standard wood framing and plywood surfacing techniques or may be built as a SIP panel.

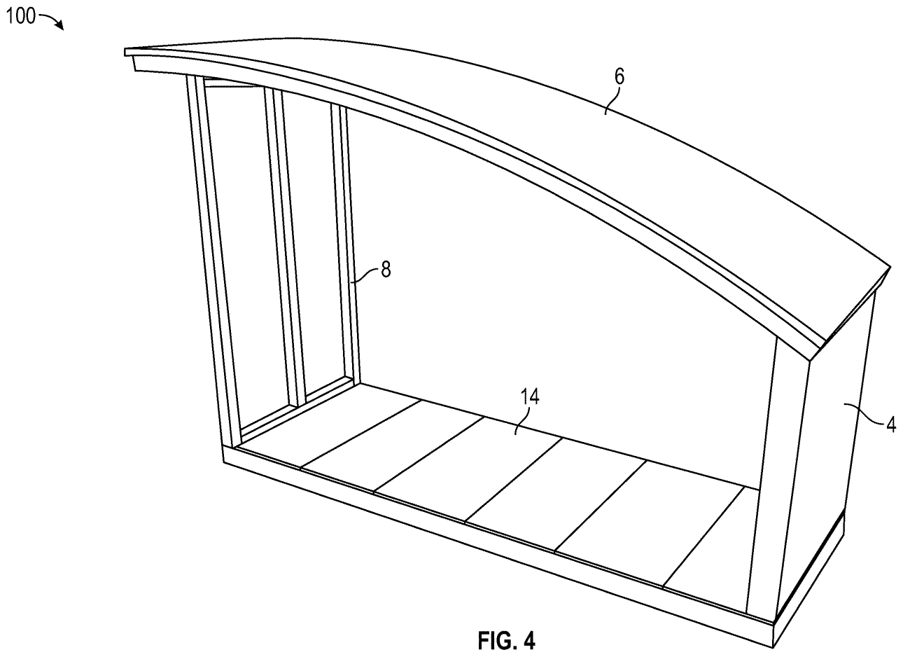

A modular housing construction system 100 generally has a top, a bottom, a front and a rear. There is a floor panel 14 having a front end 46 and a rear end 48. The roof panel 6 has a front end 32 and a rear end 34. The front wall panel 8 has a top end 42 and a bottom end 44. The rear wall panel 4 has a top end 38 and a bottom end 36. The roof panel rear end 34 is fixedly connected to the rear wall panel top end 38. A top hinge 52 connects the front wall panel top end 42 to the roof panel front end 32. A rear hinge 16 connects the floor panel rear end 48 to the rear wall panel bottom end 36. The front panel bottom end 44 is in a sliding arrangement with an upper surface of the floor panel 14. In one aspect, sliding the front panel bottom end 44 along the floor panel 4 towards the floor panel front end 46 elevates the roof panel 6 relative to the floor panel 4. Additionally, sliding the front panel bottom end 44 along the floor panel 4 towards the floor panel front end 46 moves the top hinge 52 connecting the front end of the roof panel 32 and the front panel top end 42. Additionally or optionally, sliding the front panel bottom end 44 along the floor panel 4 towards the floor panel front end 46 moves the rear wall panel top end 38 towards a vertical orientation relative to the floor panel 4. Additionally or optionally, sliding the front panel bottom end 44 along the floor panel 4 towards the floor panel front end 46 moves the rear hinge connection 16 to change the orientation of the rear wall panel top end 38 relative to the floor panel 4. In one embodiment, the top hinge 52 is positioned 8 feet from the roof panel front end 32. In another embodiment, the rear hinge 16 is positioned from about 6 inches to about 24 inches from floor panel rear end 48 so as to align the rear panel bottom end 36 with the floor panel rear end 48. In one aspect, the rear hinge 16 is spaced from the rear edge of the floor panel so that when in the upright and final position (i.e., FIG. 4) the rear wall face and the rear end of the floor panel are nearly aligned as shown in FIG. 4. In one variation, the rear hinge is spaced in a different position relative to the floor panel rear face so that either the rear wall face is set back from the edge of the floor panel creating a ledge along the rear wall and the floor panel or, alternatively, spaced closer to the edge so that a portion of the rear wall overhangs the rear edge of the floor panel.

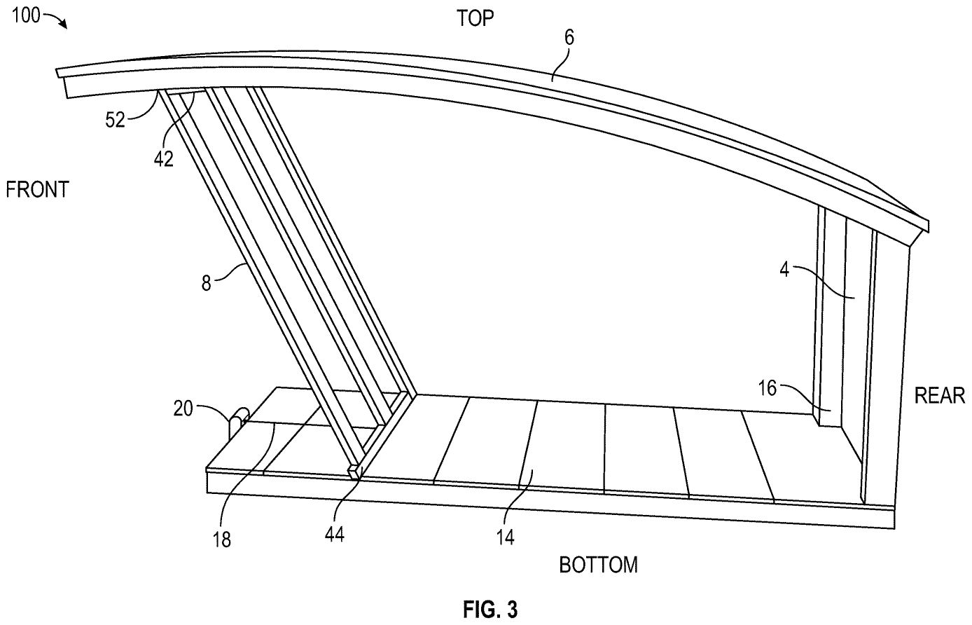

FIG. 3 is a perspective view showing the structure partially raised. The roof 6 is raised by on cable 18 via a crank or winch 20 until the front wall 8 is in its final approximately vertical position as shown in FIG. 4. FIG. 3 also shows hinge 16 which connects roof wall 6 and 4, to floor panel 14. allowing the roof panel 6 and 4 into it final use position.

FIG. 4 shows the modular construction module 100 in its fully erected state.

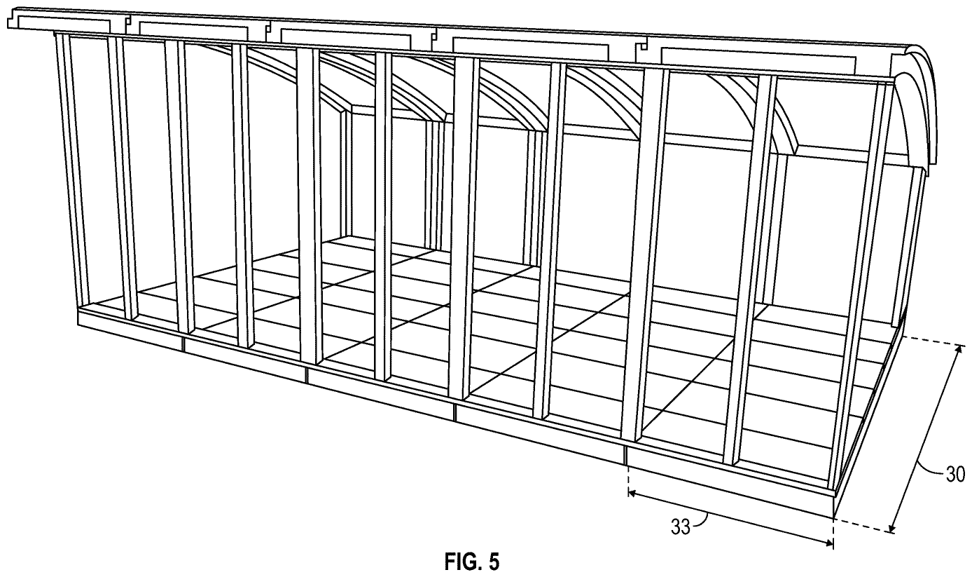

FIG. 5 show a perspective view of a plurality of modular structures attached to each other side by side forming a single larger structure. Each module as currently shown offer 23 feet of length, and 8 feet of width, providing 184 square of floor space.

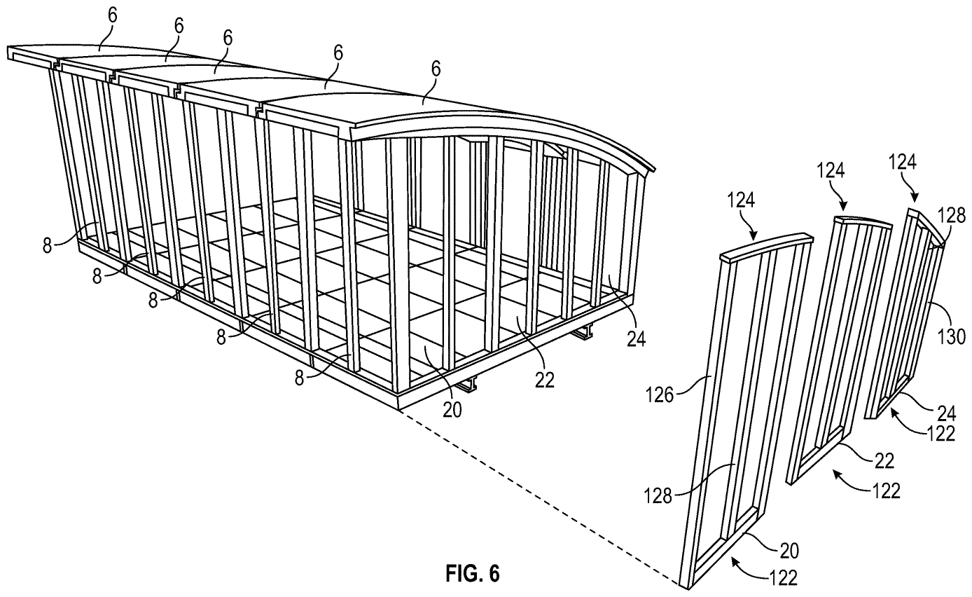

FIG. 6 is a perspective view showing right side panels 20, 22, 24 about to be installed on the right side of modular structure. The panels 20, 22, 24 are sized so that each panel width is approximately 7 feet six inches making them easily transported on the floor area of the module in its transport mode.

In still other embodiments, the modular construction system includes a plurality of left and right-side panels particularly adapted to conform to the spacing between the roof panel 6 and the floor panel 4. In one embodiment, there is a front portion side panel 20, a mid-portion side panel 22 or a rear portion side panel 24. Each of the side panels has a top end 124 shaped to conform to a curvature of the roof panel adjacent to that side panel. Each side panel also has a bottom end to attach to the floor panel 4. Each side panel has a front upright 126, a rear upright 130 and a middle upright 128 between the front and rear uprights. More particularly, the front side panel 20 has a front upright 126 adapted and configured for attachment to and along the front wall panel 8. Additionally, the rear upright 130 of the rear side panel 24 is adapted and configured for attachment to the rear wall panel 4 and the roof panel 6 adjacent to the roof panel rear end 34. In still other aspects, the front upright 126 of the middle side panel 22 is adapted and configured for corresponding attachment to the rear upright 130 of the front side panel 20. In still other aspects, the rear upright 130 of the middle side panel is adapted and configured to corresponding attachment to the front upright 126 of the rear side panel 24.

Additionally or optionally, the front portion panel 20 has a bottom surface or end 122 adapted and configured for attachment to the floor panel 4 and an upper surface or top end 124 adapted and configured for conforming along and attaching to a portion of the roof panel in a front portion. The front portion panel 20 also has a front upright 126 adapted and configured to conform to the front wall panel 8. There is a rear upright 130 and a middle upright 128 between the front upright 126 and the rear upright 130. a rear portion panel has a bottom surface adapted and configured for attachment to the floor panel, an upper surface adapted and configured for conforming to a portion of the roof panel and an edge portion adapted and configured for attachment to the rear wall panel, wherein a mid-portion panel has a bottom surface adapted and configured for attachment to the floor panel and an upper surface adapted and configured for conforming to a portion of the roof panel between the front panel portion and the rear panel portion.

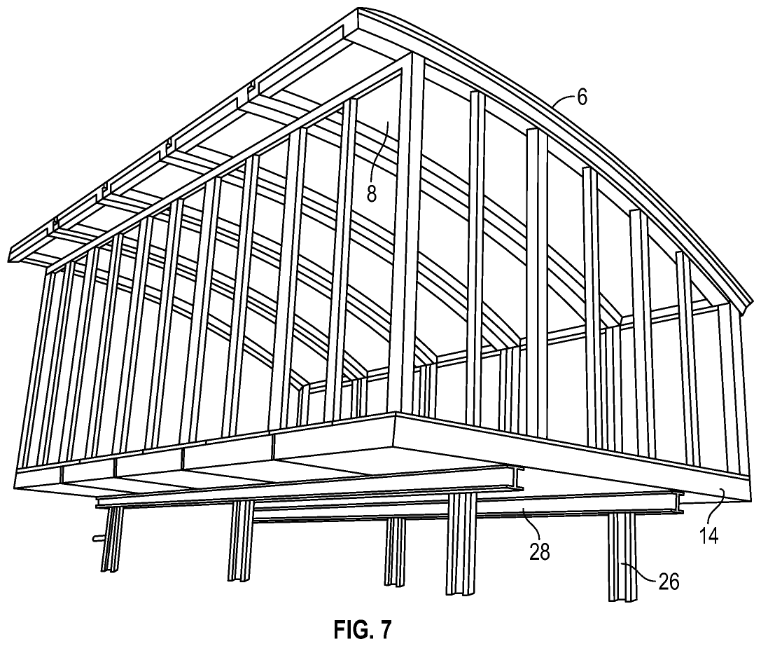

FIG. 7 is a view of the completed modular structure mounted on a support structure 26, 28 that allow it to be secured to the ground no matter what the terrain. It should be noted that operable window and or doors can be incorporated into the front walls or side walls.

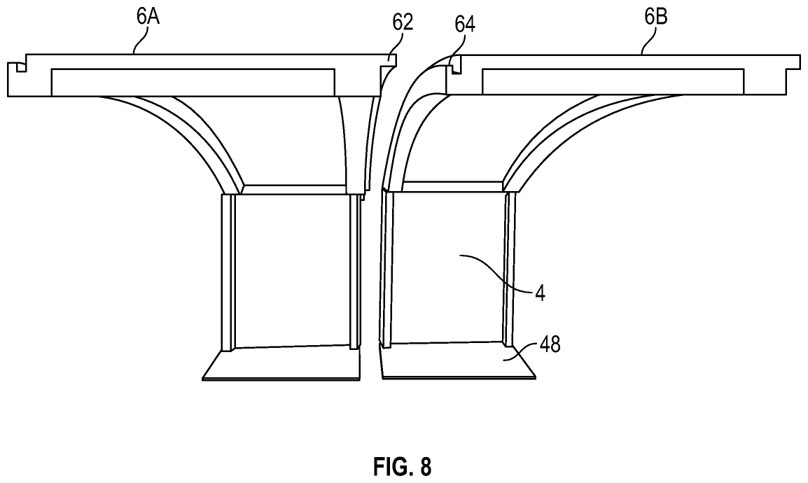

FIG. 8 is a perspective view of two roof panels 6A and 6B about to be joined together. An upper protrusion 62 is about to be slid on top of underlapping protrusion 64.

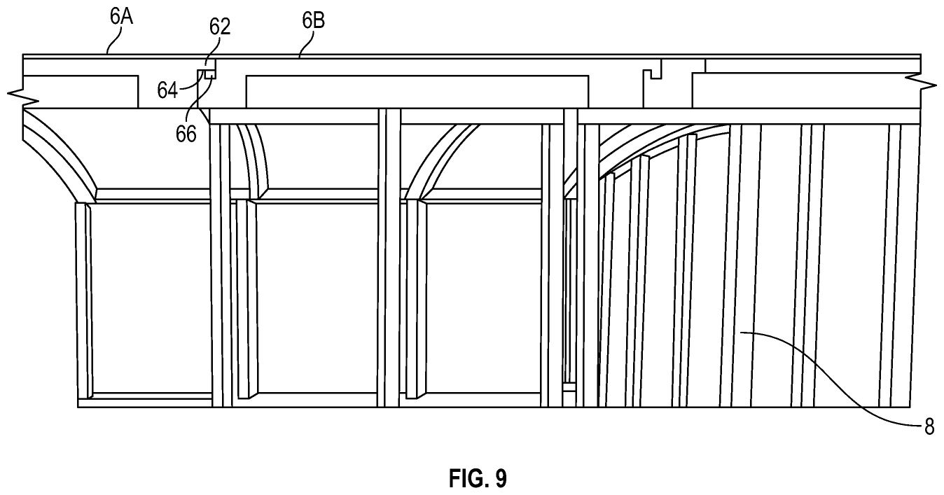

FIG. 9 is a perspective view showing two roof panels 6A, and 6B attached together creating a watertight seal. The resulting hollow channel 66 allows water to exit the space between upper protrusion 62 and lower protrusion 64.

FIG. 10 Module oriented to create a large workspace.

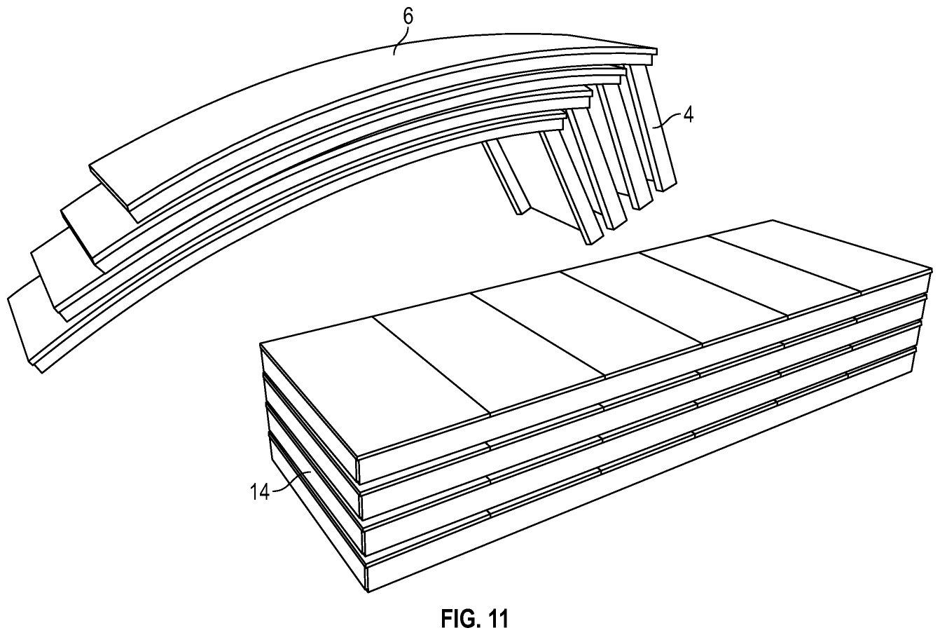

FIG. 11 separated module sections stacked for storage.

### Exemplary Uses

### A Conventional Residential Structure

Multiple roofs, floor, wall modules are hauled out to the jobsite using SUVs or pickup trucks. Once at the site, modules' roof sections are raised, and the modules are positioned, and fit together. Then side walls sections are applied. These assembled modules can be left on their trailer chassis or mounted on to “I” beam foundations. (See for example FIG. 7) Modules can also be assembled temporarily while waiting for foundation issues to be worked out with the local building department. Once approval is received, the modules are repositioned onto their foundations.

### Elevated Structure

When using the basic “I” beam foundation, the structure can be elevated by extending the length of the vertical “I” beam posts. This could be good for flood zones, and also for parking underneath the main structure. A crane may be needed to lift the modules into place.

### Rotating Structures

Modules could be assembled on a turntable like base structure. This could allow for the structure to be rotated around to modulate interior temperature based upon the structures orientation to the Sun. Facing the sun to warm up. Away from the Sun to cool down.

### Floating Structures

Three modules could be fitted onto two pontoons to create a catamaran houseboat type assembly. Pontoons would be 40-45 feet long and 8 feet wide. The pontoons could have rooms incorporated in them. These would also be designed to haul down the road without wide load or overpass issues.

### Quick Temporary Housing (Useful for Disaster Relief, or Military Housing)

Since the separate module components stack. Many of these could be efficiently warehoused at a central location. They could easily be assembled for transport. Once there is no longer a need for these buildings, the modules could be separated, folded back up, take back to a storage facility, and restacked for reuse.

### Larger Working Structures

Large open area structures could also be produced using the monolithic roof/wall sections, and the floor sections. In this use, modules are not only oriented in a liner way, but also face each other. So that the tall open ends butt up to each other. This can be performed using some minor additional adaptor panels.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims. The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A modular housing construction system, comprising:
a floor panel having a front end and a rear end;
a roof panel having a front end and a rear end;
a front wall panel having a top end and a bottom end; and
a rear wall panel having a top end and a bottom end; wherein,
the roof panel rear end is fixedly connected to the top end of the rear wall panel,
a top hinge connecting the front wall panel top end to the roof panel front end,
a rear hinge connecting the floor panel rear end to the rear wall panel bottom end, and
the front panel bottom end is in a sliding arrangement with the floor panel.

2. The system of claim 1 wherein sliding the front panel bottom end along the floor panel towards the floor panel front end elevates the roof panel relative to the floor panel.

3. The system of claim 1 wherein sliding the front panel bottom end along the floor panel towards the floor panel front moves the top hinge connection between the front end of the roof panel and the front panel top end.

4. The system of claim 1 wherein sliding the front panel bottom end along the floor panel towards the floor panel front end moves the rear wall panel top end towards a vertical orientation relative to the floor panel.

5. The system of claim 1 wherein sliding the front panel bottom end along the floor panel towards the floor panel front end moves the rear hinge connection to change the rear wall panel top end relative to the floor panel.

6. The system of claim 1 wherein the top hinge is positioned 8 feet from the roof panel front end or at a distance to provide an overhang of a portion of the roof panel front end over the floor panel front end.

7. The system of claim 1 wherein the rear hinge is positioned from floor panel rear end so as to align the rear panel bottom with the floor panel rear end, to form a ledge between the rear wall and the floor panel or to form an overhang of a portion of the rear wall over the floor panel rear end.

8. The system of claim 1 the roof panel further comprising a left side and a right side extending from the front end to the rear end, the left side or the right side having an upper protrusion or a lower protrusion for joining to an adjacent roof panel.

9. The system of claim 8 wherein when the roof panel is joined to an adjacent roof panel there is a hollow channel between the roof panels.

10. The system of claim 1 further comprising joining together a plurality of single module assemblies in side-by-side arrangement to form a housing structure of a desired width.

11. The system of claim 1 wherein the modular housing system is adapted and configured for transportation on a trailer hauled by a conventional pick-up truck or SUV type vehicle or a vehicle having a towing capacity of 2,500 pounds to 5,000 pounds.

12. The system of claim 11 wherein when the modular housing system is in a transportation configuration on a trailer the highest point is the roof panel above the rear wall panel and that highest point is less than 13 feet above a roadway and the longest portion of the modular housing system is the front end of the roof panel and that longest portion is less than 32 feet from a front end of the trailer holding the modular housing system.

13. The system of claim 1 further compromising a plurality of a left and right-side wall panels sized to enclose the space created by the roof panel, the rear wall panel, the floor panel, and the front wall panel.

14. The system of claim 13 wherein the each side panel of the plurality of left and right side panels is one of a front portion panel, a mid-portion panel or a rear portion panel wherein a front portion panel has a bottom surface adapted and configured for attachment to the floor panel and an upper surface adapted and configured for conforming along and attaching to a portion of the roof panel, wherein a rear portion panel has a bottom surface adapted and configured for attachment to the floor panel, an upper surface adapted and configured for conforming to a portion of the roof panel and an edge portion adapted and configured for attachment to the rear wall panel, wherein a mid-portion panel has a bottom surface adapted and configured for attachment to the floor panel and an upper surface adapted and configured for conforming to a portion of the roof panel between the front panel portion and the rear panel portion.

15. The system of claim 1 wherein said roof member and said rear wall member are molded of fire-retardant class 1 composite monolithic fiberglass and foam insulation.

16. The system of claim 1 further comprising a cable coupled to the front wall panel bottom end wherein pulling the cable slides the front wall panel bottom end towards the floor panel front end while also raising the roof panel above the floor panel.

17. The system of claim 16 further comprising a winch adapted and configured for pulling the cable until the roof section is raised into a final position.

18. A method of forming a modular housing structure comprising:
Pulling a cable attached to the front wall panel bottom end of the modular housing construction system of claim 1 towards the floor panel front end until the front wall panel is in a vertical orientation with the front panel bottom is flat against the flooring panel.

19. The method of claim 18 wherein after the pulling step is completed the rear wall panel is in a vertical orientation and the rear wall panel bottom end is flat against the floor panel.
